(19) United States
(12) Patent Application Publication
(10) Pub. No.: US 2016/0292711 A1
(43) Pub. Date: Oct. 6, 2016

(54) COUPON APPARATUS, USER EQUIPMENT, SERVICE PROVIDING DEVICE, CONTROL METHOD THEREOF AND NON-TRANSITORY COMPUTER READABLE STORAGE MEDIUM HAVING COMPUTER PROGRAM RECORDED THEREON

(71) Applicant: SK PLANET CO., LTD., Seongnam-si (KR)

(72) Inventors: Yong Yeon CHO, Seoul (KR); Hwan Won CHOI, Seoul (KR); Jeen Woo PARK, Yangpyeong-gun, Gyeonggi-do (KR)

(21) Appl. No.: 14/952,372

(22) Filed: Nov. 25, 2015

(30) Foreign Application Priority Data
Apr. 2, 2015 (KR) 10-2015-0046718

(51) Int. Cl. G06Q 30/02

(52) U.S. Cl. CPC G06Q 30/0238; G06Q 30/0239

(57) ABSTRACT

Provided are a coupon apparatus, user equipment, a service providing device, a control method thereof, and a non-transitory computer readable storage medium having computer program recorded thereon. That is, according to the present invention, it is possible to issue a coupon in a non-affiliated store and improve convenience of a user by easily issuing the coupon, by issuing the coupon according to a real-time sales situation of the store by a simple operation in a non-affiliated/affiliated store.

### CROSS-REFERENCE TO RELATED APPLICATION

This application claims the benefit of Korean Application No. 10-2015-0046718 filed on Apr. 2, 2015 with the Korean Intellectual Property Office, the disclosure of which is incorporated herein by reference.

### BACKGROUND OF THE INVENTION

1. Field of the Invention

The present invention relates to a coupon apparatus, user equipment, a service providing device, a control method thereof, and a non-transitory computer readable storage medium having computer program recorded thereon, and more particularly, to a coupon apparatus, user equipment, a service providing device, a control method thereof, and a non-transitory computer readable storage medium having computer program recorded thereon for issuing a coupon according to a real-time sales situation of a store by a simple operation in a non-affiliated/affiliated store.

2. Description of the Related Art

A coupon issuing system is an apparatus for issuing a coupon in an on/off store.

Such a coupon issuing system issues the coupon based on a cumulative experience point, a seasonal demand, and the like without detailed data for demand information of actual demanders to use the coupon, and thus, an actual use rate of the issued coupon is significantly low, it is difficult to be an immediate help to a current sales due to the issued coupon in quantity, and a current situation of the store is not reflected in real time.

### SUMMARY OF THE INVENTION

An object of the present invention is to provide a coupon apparatus, user equipment, a service providing device, a control method thereof, and a non-transitory computer readable storage medium having computer program recorded thereon for issuing a coupon according to a real-time sales situation of a store by a simple operation in a non-affiliated/affiliated store.

Another object of the present invention is to provide a coupon apparatus, user equipment, a service providing device, a control method thereof, and a non-transitory computer readable storage medium having computer program recorded thereon for issuing a coupon of which a coupon discount rate, a discount time, a quantity, and the like are adjusted in real time at a desired time of a coupon provider.

According to an aspect of the present invention, a coupon apparatus includes: a main body; a display unit formed on one surface of the main body and configured to receive input values for a plurality of items for generating coupon information according to a user's touch; a plurality of dials formed on the other surface of the main body and configured to select the input values for the plurality of items for generating the coupon information according to a user's operation; a control unit configured to set the coupon information based on the input values received through the display unit or selected through the plurality of dials; and a communication unit configured to transmit the set coupon information to a beacon or a service providing device.

In an embodiment of the present invention, the coupon information may include at least one of a store name, a product name, store location information, a discount rate, a period, a quantity, and coupon issuance range information, and the coupon issuance range information may include at least one of in-store, a predetermined short distance from the store, a location base based on the store, an optimal location base based on store based business type related area information, and a predetermined range.

In an embodiment of the present invention, the display unit and the plurality of dials may interlock with each other, and when input values to be included in the coupon information is received from the display unit, a state of the dials corresponding to the input values received from the display unit may be changed according to the received input values, and when the input values to be included in the coupon information are selected from the dials, a screen of the display unit corresponding to the input values selected from the dials may be changed according to the selected input values.

In an embodiment of the present invention, the control unit may control the communication unit to generate a coupon based on the set coupon information and broadcast the generated coupon based on the coupon issuance range information included in the coupon information.

In an embodiment of the present invention, the coupon may include at least one of a store name, a product name, store location information, a discount rate, a period, a quantity, a barcode, and a QR code.

According to another aspect of the present invention, a control method of a coupon apparatus includes: receiving input values for a plurality of items for generating coupon information according to a user's touch by means of a display unit which is formed one surface of a main body; receiving the input values for the plurality of items for generating the coupon information according to a user's operation by means of a plurality of dials which is formed on the other surface of the main body; setting coupon information including at least one of a store name, a product name, store location information, a discount rate, a period, a quantity, and coupon issuance range information based on the input values received through the display unit or the plurality of dials by means of a control unit; generating a coupon including at least one of a store name, a product name, store location information, a discount rate, a period, a quantity, a barcode, and a QR code based on the set coupon information by means of a communication unit; and broadcasting the generated coupon based on the coupon issuance range information included in the coupon information by means of the communication unit.

In an embodiment of the present invention, the broadcasting of the generated coupon may include at least one of broadcasting the coupon in the store where a coupon apparatus including the communication unit is installed by means of the communication unit, when the in-store is included in the coupon issuance range information; broadcasting the coupon within a predetermined distance in the store by means of the communication unit, when the predetermined short distance from the store is included in the coupon issuance range information; broadcasting the coupon within a predetermined radius from the store by means of the communication unit, when the location base based on the store is included in the coupon issuance range information; and broadcasting the coupon within a predetermined area based on the corresponding store based on pre-analyzed commercial area information by means of the communication unit, when the optimal location base based on store based business type related area information is included in the coupon issuance range information.

According to yet another aspect of the present invention, a computer program executing the methods according to the aforementioned embodiments may be stored in a non-transitory computer readable storage medium having a computer program recorded thereon.

According to still another aspect of the present invention, a coupon issuing system includes: a coupon apparatus configured to set coupon information by means of a screen displayed on a display unit or a plurality of dials and transmit the set coupon information; a service providing device configured to generate a coupon based on the coupon information transmitted from the coupon apparatus and broadcast the generated coupon based on coupon issuance range information included in the coupon information; a beacon configured to generate the coupon based on the coupon information transmitted from the coupon apparatus and broadcast the generated coupon in the store or within the predetermined distance from the store based on the coupon issuance range information included in the coupon information; and user equipment configured to receive the coupon broadcasted from the service providing device or the beacon and store the received coupon.

In an embodiment of the present invention, the coupon issuing system may further include a POS terminal configured to recognize the coupon stored in the user equipment and perform a payment function for a payment amount to which the recognized coupon is applied, in the case of using the coupon stored in the user equipment.

As described above, according to the present invention, it is possible to issue a coupon in a non-affiliated store and improve convenience of a user by easily issuing the coupon, by issuing the coupon according to a real-time sales situation of the store by a simple operation in a non-affiliated/affiliated store.

Further, it is possible to maximize a coupon issuing effect by controlling the coupon issuance according to a situation of stores which a coupon provider belong to by issuing a coupon of which a coupon discount rate, a discount time, a quantity, and the like are adjusted in real time at a desired time of the coupon provider.

### BRIEF DESCRIPTION OF THE DRAWINGS

FIG. 1 is a block diagram illustrating a configuration of a coupon issuing system according to an embodiment of the present invention.

FIG. 2 is a block diagram illustrating a configuration of a coupon apparatus according to the embodiment of the present invention.

FIG. 3 is a diagram illustrating a drum type coupon apparatus according to the embodiment of the present invention.

FIG. 4 is a flowchart illustrating a control method of a coupon issuing system according to another embodiment of the present invention.

FIG. 5 is a diagram illustrating a coupon apparatus for setting coupon information according to yet another embodiment of the present invention.

FIG. 6 is a diagram illustrating a screen of user equipment according to the embodiment of the present invention.

FIG. 7 is a flowchart illustrating a control method of a coupon issuing system according to a second embodiment of the present invention.

FIG. 8 is a diagram illustrating a display unit of the coupon apparatus for setting coupon information according to the embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included. In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

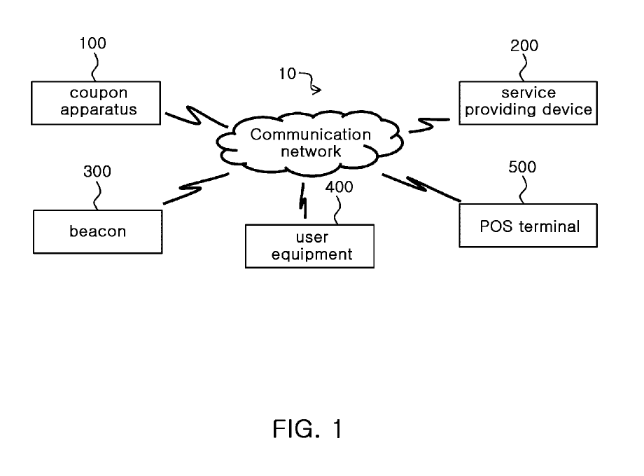

FIG. 1 is a block diagram illustrating a configuration of a coupon issuing system 10 according to an embodiment of the present invention.

As illustrated in FIG. 1, the coupon issuing system is constituted by a coupon apparatus 100, a service providing device 200, a beacon 300, user equipment 400, and a POS terminal 500. All the constituent elements of the coupon issuing system 10 illustrated in FIG. 1 are not essential constituent elements, and the coupon issuing system 10 may be implemented by more constituent elements than the constituent elements illustrated in FIG. 1 or less constituent elements therethan.

Coupon information is set through the coupon apparatus 100 by a simple operation of a store owner in a store where the coupon apparatus 100 is installed. Thereafter, the coupon apparatus 100 transmits the set coupon information to the service providing device 200 or the beacon 300. Thereafter, the service providing device 200 or the beacon 300 generates a coupon based on the coupon information transmitted from the coupon apparatus 100 and broadcasts (alternatively, transmits/issues) the corresponding generated coupon to one or more user equipment 400 based on coupon issuance range information included in the corresponding coupon information. Thereafter, the user equipment 400 receives the coupon broadcasted from the service providing device 200 or the beacon 300 and stores the received coupon. Thereafter, in the case of using the coupon stored in the corresponding user equipment 400, the user equipment 400 recognizes the coupon stored in the corresponding user equipment 400 through the coupon apparatus 100 or the POS terminal 500 and performs a payment function for a payment amount applying a discount rate included in the recognized coupon by interlocking among the POS terminal 500, the user equipment 400, and a payment server (not illustrated).

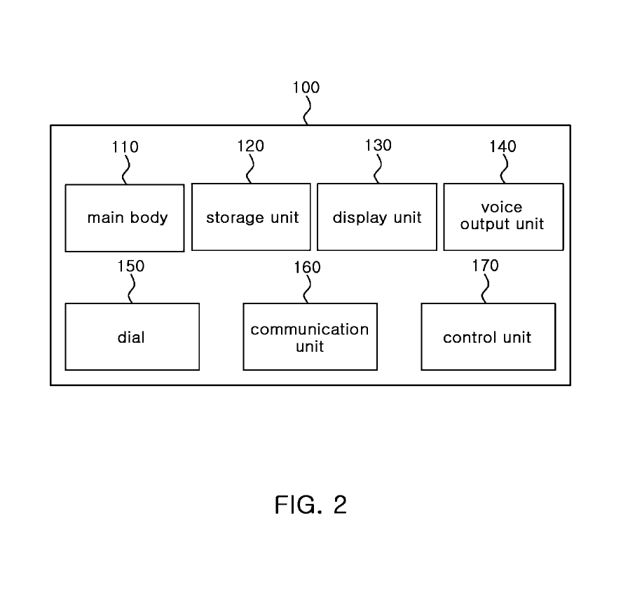

As illustrated in FIG. 2, the coupon apparatus 100 is constituted by a main body 110, a storage unit 120, a display unit 130, a voice output unit 140, a plurality of dials 150, a communication unit 160, and a control unit 170. All the constituent elements of the coupon apparatus 100 illustrated in FIG. 2 are not essential constituent elements, and the coupon apparatus 100 may be implemented by more constituent elements than the constituent elements illustrated in FIG. 2 or less constituent elements therethan.

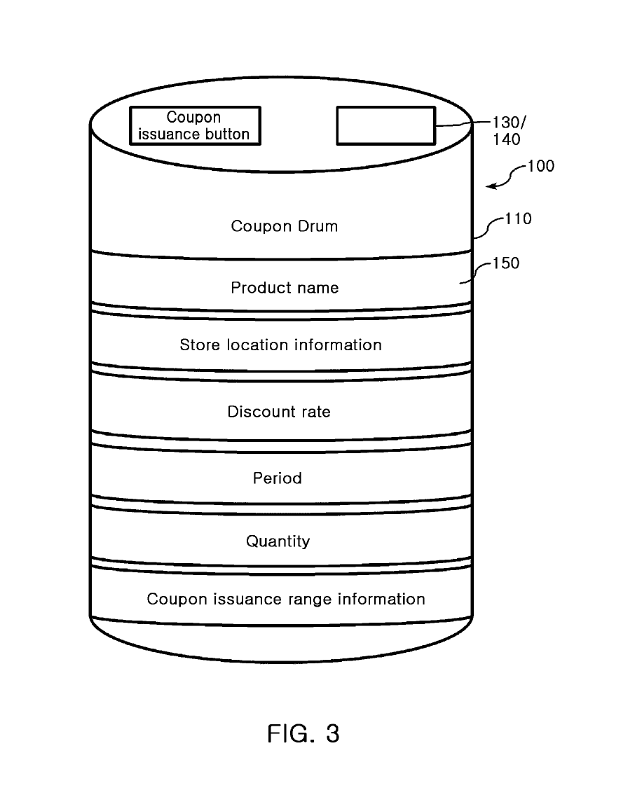

Further, as illustrated in FIG. 3, the coupon apparatus 100 may be formed (alternatively, constituted) in a drum shape.

The main body 110 is constituted in a drum shape.

Further, the main body 110 may be variously designed in other shapes in which it is easy to operate the plurality of dials 150.

The storage unit 120 stores various user interfaces (UI), graphic user interfaces (GUI), and the like.

Further, the storage unit 120 stores data, programs, and the like which are required to operate the coupon apparatus 100.

That is, the storage unit 120 may store a plurality of application programs (alternatively, applications) driven in the coupon apparatus 100 and data and commands for the operation of the coupon apparatus 100. At least some of the application programs may be downloaded from an external service providing device through wireless communication. Meanwhile, the application program is stored in the storage unit 120 and installed on the coupon apparatus 100 to be driven to perform an operation (alternatively, a function) of the coupon apparatus 100 by the control unit 170.

Further, the storage unit 120 may include at least one storage medium of a flash memory type, a hard disk type, a multimedia card micro type, a card type memory (for example, an SD or XD memory, or the like), a magnetic memory, a magnetic disk, an optical disk, a random access memory (RAM), a static random access memory (SRMA), a read-only memory (ROM), an electrically erasable programmable read-only memory (EEPROM), and a programmable read-only memory (PROM). Further, the coupon apparatus 100 may operate a web storage performing a storage function of the storage unit 120 on the Internet or operate in association with the web storage.

Further, the storage unit 120 stores a dedicated app and the like storing and managing the coupon by a control of the control unit 112.

The display unit 130 is formed on one surface (alternatively, one side) of the main body 110.

That is, as illustrated in FIG. 3, the display unit 120 may be formed on the upper surface of the main body 110.

Further, the display unit 130 may display various contents such as various menu screens by using the UI and/or the GUI stored in the storage unit 120 by the control of the control unit 170. Here, the contents displayed on the display unit 130 include a menu screen including various texts or image data (including various information data) and data such as icons, a list menu, and a combo box, and the like. Further, the display unit 130 may be a touch screen. In this case, a touch sensor for sensing a touch gesture of the user may be included. The touch sensor may be one of various types such as a capacitive type, a decompressive type, and a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition, the user equipment may support a pen input function, and in this case, a user's gesture using an input means such as a pen rather than the part of the user's body may be sensed. As an example, in the case where the input means is a stylus pen including a coil therein, the user equipment may include a magnetic field sensor for sensing a magnetic field changed by the coil in the stylus pen. In this case, an approaching gesture of the user such as hovering in addition to the touch gesture of the user may be sensed.

Further, the display unit 130 may be implemented by at least one form of a liquid a liquid crystal display (LCD), a thin film transistor-liquid crystal display (TFT LCD), an organic light-emitting diode (OLED), a flexible display, a 3D display, an electronic ink (e-ink) display, and a light emitting diode (LED) and may include a driving circuit therefor, a backlight unit, and the like together.

Further, the display unit 120 may be constituted as a stereoscopic display unit displaying a stereoscopic image.

A 3D display type such as a stereoscopic type (a glasses type), an auto-stereoscopic type (a glassless type), and a projection type (a holographic type) may be applied to the stereoscopic display unit.

Further, the display unit 130 displays a screen for generating the coupon information by the control of the control unit 170.

Further, the display unit 130 receives (alternatively, input) a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like) in order to generate the coupon information based on the touch (alternatively, selection) of the user (alternatively, the operator) on the screen displayed on the display unit 130.

Further, the display unit 130 transfers the received (alternatively, input) corresponding information to the control unit 170.

Further, the display unit 130 displays coupon information, a coupon, and the like set (alternatively, generated) by the control of the control unit 170.

The voice output unit 140 is formed on one surface (alternatively, one side) of the main body 110.

Further, the voice output unit 140 outputs voice information included in a signal signal-processed by the control unit 170. Here, the voice output unit 140 may include a receiver, a speaker, a buzzer, and the like.

Further, the voice output unit 140 outputs a guidance voice generated by the control unit 170.

Further, the voice output unit 140 outputs voice information corresponding to the coupon information, the coupon, and the like set (alternatively, generated) by the control unit 170, respectively.

A dial (alternatively, a wheel) 150 is formed on one surface (alternatively, one side) of the main body 110.

That is, as illustrated in FIG. 3, the dial 150 may be formed on the side of the main body 110.

Further, the dial 150 rotates in a clockwise direction or a counterclockwise direction by the operation of the user to set (alternatively, operate/control) a value displayed on each dial 150.

As such, the dial 150 provided in the drum type main body 110 rotates to control the value to be set in the coupon information, thereby simply controlling the coupon information, improving convenience of the user, and causing an interest.

Further, one or more (alternatively, a plurality of) dials 150 are constituted to correspond to values to be set in the coupon information.

Further, the display unit 130 and the dial 150 interlock with each other.

That is, when the value to be included in the coupon information is selected from the display unit 130, a state of the dial 150 corresponding to the value selected in the display unit 130 is changed (alternatively, applied) depending on the value selected to the corresponding display unit 120.

For example, when a discount rate (for example, 10%) to be included in the coupon information is selected in the display unit 130, a state of the dial 150 corresponding to the discount rate item selected in the display unit 130 is changed to be matched with the discount rate (for example, 10%) selected to the corresponding display unit 120.

Further, when the value included in the coupon information is selected in the dial 150, a screen of the display unit 130 corresponding to the value selected in the dial 150 is changed (alternatively, applied/updated) depending on the value selected to the corresponding dial 150.

For example, when the quantity (for example, a remaining quantity of 10) is selected in the dial 150, a state of the display unit 130 corresponding to the quantity item selected in the dial 150 is changed to be suitable for the quantity (for example, a remaining quantity of 10) selected in the corresponding dial 150.

The communication unit 160 communicates with any internal constituent element or at least one external terminal via a wired/wireless communication network. In this case, any external terminal may include the service providing device 200, the beacon 300, the user equipment 400, the POS terminal 500, and the like. Here, a wireless Internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), or the like, and the communication unit 160 transmits and receives data according to at least one wireless Internet technique in a range including internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Further, the wired communication technique may include power line communication (PLC), USB communication, Ethernet, serial communication, optical/coaxial cable, or the like.

Further, the communication unit 160 may transmit the information with any terminal through a universal serial bus (USB).

Further, the communication unit 160 transmits and receives a wireless signal to and from at least one of a base station, the service proving device 200, the beacon 300, the user equipment 400, and the POS terminal 500 on a mobile communication network constructed according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the communication unit 160 transmits the coupon information, the coupon, and the like set (alternatively, generated) by the control of the control unit 170.

Further, the communication unit 160 forms (alternatively, constitutes) access (alternatively, connection/session) to the beacon 300 and the like by the control of the control unit 170.

Further, the communication unit 160 communicates with the beacon 300 and the like through Bluetooth low energy (hereinafter, referred to as ‘BLE’) by the control of the control unit 170.

Here, the BLE means a core function of Bluetooth Ver 4.0 as one of the short range communication techniques. The BLE has a relatively small duty cycle as compared with a classic Bluetooth standard and may operate for several years with a battery which may be produced with low cost and has a coin size by reducing average power and standby power.

Further, a communication radius of a BLE device between the communication unit 160 and the beacon 300 means a distance (for example, 1 m to 100 m) capable of receiving data (alternatively, a BLE beacon signal/an advertisement signal/an advertisement packet) broadcasted from the beacon 300 in the communication unit 160. Here, the corresponding communication radius may be variable according to a communication situation. Further, the communication radius of the corresponding BLE device may be randomly set by the user. For example, the user may set a predetermined area such as a living room, a kitchen, and the entire home as the communication radius of the BLE device and may also set a predetermined distance (for example, 5 m) as the communication radius of the BLE device.

The control unit 170 executes an overall control function of the coupon apparatus 100.

Further, the control unit 170 executes the overall control function of the coupon apparatus 100 by using the programs and data stored in the storage unit 120. The control unit 170 may include a RAM, a ROM, a CPU, a GPU, and a bus, and the RAM, the ROM, the CPU, the GPU, and the like may be connected to each other through the bus. The CPU accesses the storage unit 120 to perform booting by using an O/S stored in the storage unit 120 and may perform various operations by using various programs, contents, data, and the like stored in the storage unit 120.

Further, the control unit 170 displays a screen for setting the coupon information (alternatively, generating the coupon information) on the display unit 130.

Further, the control unit 170 controls the plurality of dials 150 and the corresponding display unit 130 to be operated by interlocking with each other.

Further, the control unit 170 sets (alternatively, generates) the coupon information. In this case, the coupon information includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like).

That is, when respective values included in the corresponding coupon information are set on the screen for setting the coupon information (alternatively, generating the coupon information) displayed on the display unit 130, the control unit 170 sets the coupon information based on the values set above.

Further, when the plurality of dials 150 corresponding to the respective items included in the corresponding coupon information is adjusted by the operation (alternatively, control) of the plurality of dials 150, the control unit 170 sets the coupon information based on the respective values adjusted by the plurality of dials 150.

Further, the control unit 170 transmits the set coupon information to the service providing device 200, the beacon 300, and the like through the communication unit 160.

That is, in the case where the location base based on the store, the optimal location base based on store based business type related area information, the predetermined range/radius/distance, and the like are included in the coupon issuance range information included in the coupon information, the control unit 170 transmits the set coupon information to the service providing device 200 through the communication unit 160.

Further, in the case where the in-store, the predetermined short distance from the store, and the like are included in the coupon issuance range information included in the coupon information, the control unit 170 transmits the set coupon information to the beacon 300 through the communication unit 160.

Further, while the coupon is issued through the service providing device 200 or the beacon 300, when the coupon issuance is no longer required by increasing users of the corresponding coupon, the discount rate of the coupon is changed, or a status such as a time or a discount rate is changed because the number of issued coupons is small, that is, when the content of the coupon information provided to the service providing device 200 or the beacon 300 is changed (alternatively, corrected), the control unit 170 generates a coupon stop signal for stopping the coupon generation through a cancel button (alternatively, a change/correction button) preset in the corresponding dial 150 or the display unit 130.

Further, the control unit 170 transmits the generated coupon stop signal to the service providing device 200, the beacon 300, and the like through the communication unit 160.

Further, the control unit 170 may be constituted to issue a new coupon with the updated content by transmitting additional coupon information (alternatively, updated coupon information) additionally set by the display unit 130 or the plurality of dials 150 to the service providing device 200, the beacon 300, and the like through the communication unit 160. In this case, the additional coupon information (alternatively, the updated coupon information) includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like), like the above coupon information.

Further, when providing the coupon information, the control unit 170 adds (alternatively, inserts) unique information (alternatively, a unique code) interpretable only in the coupon apparatus 100 to the corresponding coupon information and may provide the coupon information added with the corresponding unique information to the service providing device 200 or the beacon 300.

As such, while the corresponding unique information is included together in the coupon generated through coupon information added with the unique information, when the corresponding coupon intends to be used in the user equipment 400 getting the coupon added with the unique information later, the corresponding coupon (alternatively, the coupon added with the unique information) is recognized through only the coupon apparatus 100 to enhance safety for coupon authentication.

Further, the control unit 170 may be constituted to convert the coupon (alternatively, the coupon added with the unique information) recognized in the coupon apparatus 100 into information (for example, a recognizable universal barcode) recognizable in the POS terminal 500 and provide the converted information to the POS terminal 500 to apply a discount benefit according to the coupon in the corresponding POS terminal 500.

Further, in order to perform the payment function for one or more products to which the coupon is applied, the control unit 170 recognizes the coupon stored in the user equipment 400 through a sensor unit (not illustrated).

Further, the control unit 170 provides information on the recognized coupon to the POS terminal 500.

Further, the coupon apparatus 100 may further include an interface unit (not illustrated) serving as an interface with all external devices connected to the corresponding coupon apparatus 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip storing various information for authenticating a permission of the coupon apparatus 100 and may include a user identity module (UIM), a subscriber identity module (SIM), a universal subscriber identity module (USIM), and the like. Further, the device provided with the identification module may be prepared in a smart card form. Accordingly, the identification module may be connected with the coupon apparatus 100 through the port. Such an interface unit receives data or power from an external device to transmit the received data or power to each constituent element in the coupon apparatus 100 or transmit the data in the coupon apparatus 100 to the external device.

Further, the interface unit may be a passage through which the power from a cradle is supplied to the corresponding coupon apparatus 100 when the coupon apparatus 100 is connected with an external cradle or a passage through which various command signals input from the cradle by the user is transferred to the corresponding coupon apparatus 100. Various command signals input from the cradle or the corresponding power may also operate by a signal for recognizing that the coupon apparatus 100 is accurately installed on the cradle.

Further, the coupon apparatus 100 may further include an input unit (not illustrated) for receiving a signal according to a button operation of the user or any function selection or receiving a command or a control signal generated by an operation such as touching/scrolling the displayed screen.

The input unit as a means for receiving at least one of a user's command, selection, data, and information may include a plurality of input keys and function keys for receiving figure or text information and setting various functions.

Further, the input unit may use various devices such as a key pad, a dome switch, a touch pad (including, for example, a contact capacitive type, a pressure resistive type, an infrared sensitive type, a surface ultrasonic conductive type, an integral tension measuring type, a piezo-effect type, or the like), a touch screen, a jog wheel, a jog switch, a jog shuttle, a mouse, a stylus pen, and a touch pen. Particularly, when the display unit 130 is formed in a touch screen form, some or all of the input functions may be performed by the display unit 130.

Further, each configuration unit (alternatively, each module) of the coupon apparatus 100 may software stored on a memory (alternatively, the storage unit 120) of the coupon apparatus 100. The memory may be an internal memory of the coupon apparatus 100 and may an external memory or other types of storage devices. Further, the memory may be a non-volatile memory. The software stored on the memory may include a command set to allow the coupon apparatus 100 to perform a specific operation while executing.

Further, the storage unit 120, the display unit 130, the voice output unit 140, the communication unit 160, and the control unit 170 of the coupon apparatus 100 may be connected to each other or connected to a processor and a memory of the coupon apparatus 100.

The service providing device 200 (alternatively, a server) communicates with the coupon apparatus 100, the beacon 300, the user equipment 400, the POS terminal 500, and the like via the wired/wireless communication method.

Further, the service providing device 200 may be implemented in a form such as a web server, a database server, and a proxy server. Further, in the service providing device 200, one or more of various software which allows a network load distribution mechanism to a service device to operate on the Internet or other networks may be installed, and as a result, the service providing device 200 may be implemented by a computerized system. Further, the network may be an http network and may be a private line, Intranet, or any other networks. Furthermore, the service providing device 200 and other constituent elements may be connected to each other by a security network so as to suppress the network from being attacked by any hacker or other third parties. Further, the service providing device 200 may include a plurality of database servers, and the database server may be implemented to be separately connected with the service providing device 200 through any type of network connection including a distributed database sever architecture.

Further, the service providing device 200 performs a member joining procedure for the user of the corresponding user equipment 400 by interlocking with the user equipment 400.

Further, the service providing device 200 may also provide a corresponding specific app and the like to only the user equipment 400 joined in the corresponding service providing device 200. In this case, the service providing device 200 may manage information on the specific app and the like transmitted (alternatively, issued) to the corresponding user equipment 400 through identification information of the user equipment 400 and the like. Here, the identification information of the user equipment 400 includes a mobile directory number (MDN), a mobile IP, a mobile MAC, subscriber identification module (Sim) card unique information, a serial number, and the like.

Further, the service providing device 200 is constituted to install the corresponding specific app in the corresponding user equipment 400 by transmitting a specific app and the like which are not installed in the corresponding user equipment 400 to the user equipment 400 by interlocking with the user equipment 400. Here, the specific app may be an app (alternatively, an application program) generated for advertisement and the like in a specific company.

Further, the service providing device 200 receives the coupon information transmitted from the coupon apparatus 100. In this case, the coupon information includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like).

Further, the service providing device 200 generates a coupon based on the received coupon information. In this case, the generated coupon includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), a barcode or QR code, and the like. Here, the barcode or QR code includes information on the store name, the product name, the discount rate, the period, the quantity, and the like included in the coupon.

Further, information for automatically executing the specific app may be further included in the coupon generated by the service providing device 200.

Further, the service providing device 200 broadcasts (alternatively, transmits/issues) the above generated coupon based on the coupon issuance range information included in the coupon information.

That is, when the in-store or the predetermined short distance from the store is included in the coupon issuance range information, the service providing device 200 is constituted to broadcast the corresponding coupon in the corresponding beacon 300 by transmitting the generated coupon and the coupon issuance range information to the beacon 300.

Further, when the location base based on the store is included in the coupon issuance range information, the service providing device 200 broadcasts the above generated coupon in the predetermined radius based on the store.

Further, in the case where the optimal location base based on store based business type related area information is included in the coupon issuance range information, the service providing device 200 broadcasts the above generated coupon in the predetermined area (alternatively, district/area/radius) based on the corresponding store on the basis of commercial area information pre-analyzed in the corresponding service providing device 200.

Further, in the case where the predetermined range (alternatively, district/area/radius) is included in the coupon issuance range information, the service providing device 200 broadcasts the above generated coupon based on the corresponding range.

Further, when the coupon issuance range information is not set in the coupon information, the service providing device 200 may broadcast the above generated coupon based on a predetermined default value (for example, a predetermined radius).

Further, when the coupon issuance range information is not set in the coupon information, the service providing device 200 may be constituted to broadcast the corresponding coupon to one or more user equipment 400 adjacent to the store (alternatively, positioned in the store) in the corresponding beacon 300 by transmitting the above generated coupon to the beacon 300.

Further, the service providing device 200 receives the coupon stop signal for stopping the coupon generation transmitted from the coupon apparatus 100.

Further, the service providing device 200 stops the coupon generation and coupon issuance functions related with the corresponding coupon information based on the received coupon stop signal.

Further, the service providing device 200 receives additional coupon information (alternatively, updated coupon information) additionally transmitted from the coupon apparatus 100.

Further, the service providing device 200 generates a new coupon (alternatively, an updated coupon) based on the received additional coupon information (alternatively, the updated coupon information).

Further, the service providing device 200 broadcasts the corresponding generated new coupon (alternatively, the updated coupon) based on the coupon issuance range information included in the additional coupon information.

Further, in the case where the user equipment 400 receiving the broadcasted (alternatively, issued) coupon intends to perform the payment function by using the corresponding coupon, the service providing device 200 performs the corresponding payment function by interlocking with the user equipment 400, the POS terminal 500, a payment server (not illustrated), and the like.

Further, the service providing device 200 stores a payment function performed result (alternatively, payment information).

Further, the service providing device 200 provides the payment function performed result to the corresponding user equipment 400.

As such, the service providing device 200 generates a coupon based on the coupon information provided from the coupon apparatus 100 and broadcasts the generated coupon to provide the corresponding coupon to one or more user equipment 400, regardless of whether a pre-registered affiliated store exists in the corresponding service providing device 200.

The beacon 300 is installed in the store and a specific place (alternatively, an area) such as a store installed with the coupon apparatus 100.

Further, the beacon 300 communicates with at least any one of external terminal using a BLE scheme using the BLE. In this case, any external terminal may include the coupon apparatus 100, the service providing device 200, the user equipment 400, the POS terminal 500, and the like.

Further, the beacon 300 receives the coupon information transmitted from the coupon apparatus 100. In this case, the coupon information includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like).

Further, the beacon 300 generates a coupon based on the received coupon information. In this case, the generated coupon may be a BLE beacon signal. Here, the generated coupon includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), a barcode or QR code, and the like.

Further, information for automatically executing the specific app may be further included in the coupon generated by the beacon 300.

Further, the beacon 300 broadcasts (alternatively, transmits/issues) the above generated coupon based on the coupon issuance range information included in the coupon information.

That is, when the in-store is included in the coupon issuance range information, the beacon 300 broadcasts the generated coupon in the corresponding store.

Further, when the predetermined short distance is included in the coupon issuance range information, the beacon 300 broadcasts the above generated coupon in a communication area (alternatively, in a predetermined distance in the corresponding store) of the corresponding beacon 300.

Further, the beacon 300 receives the coupon transmitted from the service providing device 200, the coupon issuance range information in the coupon information, and the like.

Further, the beacon 300 broadcasts the corresponding coupon transmitted from the service providing device 200 based on the received coupon issuance range information.

Further, when the coupon issuance range information is not set in the coupon information, the beacon 300 may broadcast the above generated coupon based on a predetermined default value (for example, the in-store).

Further, the beacon 300 receives the coupon stop signal for stopping the coupon generation transmitted from the coupon apparatus 100.

Further, the beacon 300 stops the coupon generation and coupon issuance functions related with the corresponding coupon information based on the received coupon stop signal.

Further, the beacon 300 receives additional coupon information (alternatively, updated coupon information) additionally transmitted from the coupon apparatus 100.

Further, the beacon 300 generates a new coupon (alternatively, an updated coupon) based on the received additional coupon information (alternatively, the updated coupon information).

Further, the beacon 300 broadcasts the corresponding generated new coupon (alternatively, the updated coupon) based on the coupon issuance range information included in the additional coupon information.

As such, the beacon 300 generates a coupon based on the coupon information provided from the coupon apparatus 100 and broadcasts the generated coupon to provide the corresponding coupon to one or more user equipment 400, regardless of whether a pre-registered affiliated store exists in the corresponding beacon 300.

In the embodiment of the present invention, it is described that the service providing device 200 or the beacon 300 generates the coupon based on the coupon information transmitted from the coupon apparatus 100 and issues (alternatively, broadcasts) the generated coupon, but it is not limited thereto. The function of generating the coupon, the function of broadcasting the generated coupon, and the like may be performed in the coupon apparatus 100 based on the coupon information performed in the service providing device 200 or the beacon 300.

The user equipment 400 (alternatively, the terminal) communicates with the coupon apparatus 100, the service providing device 200, the beacon 300, the POS terminal 500, and the like. Here, the user equipment 400 may be applied to various terminals such as a smart phone, a portable terminal, a mobile terminal, a personal digital assistant (PDA), a portable multimedia player (PMP), a telematics terminal, a navigation terminal, a personal computer, a laptop computer, a slate PC, a tablet PC, an ultrabook, a wearable device (including, for example, a smartwatch, a smart glass, a head mounted display (HMD), and the like), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

Further, the user equipment 400 receives the coupon broadcasted (alternatively, transmitted/issued) from the service providing device 200 or the beacon 300. Here, the coupon includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), a barcode or QR code, and the like.

That is, when the user equipment 400 is positioned in the location base based on the store, the optimal location base based on store based business type related area information, and the predetermined range (alternatively, the radius/distance) in the coupon issuance range information included in the coupon information, the corresponding user equipment 400 receives the coupon broadcasted from the service providing device 200.

Further, when the user equipment 400 is positioned in the store and the predetermined short distance from the store in the coupon issuance range information included in the coupon information (alternatively, when the user equipment 400 is adjacent to the beacon 300 and positioned in the radius/area capable of receiving the BLE beacon signal (alternatively, coupon) transmitted (alternatively, broadcasted) from the corresponding beacon 300), the corresponding user equipment 400 receives the coupon broadcasted from the beacon 300.

Further, the user equipment 400 may scan the beacon 300 around the user equipment 400 at a predetermined interval.

Further, the user equipment 400 may scan the beacon 300 according to a user request of the corresponding user equipment 400.

Further, when the beacon 300 is scanned (alternatively, inquired/retrieved), the user equipment 400 communicates with the corresponding beacon 300 and receives the coupon broadcasted from the corresponding beacon 300.

Further, the user equipment 400 stores the received coupon.

Further, the user equipment 400 displays the received coupon. In this case, the information for automatically executing the specific app pre-installed in the user equipment 400 may be included in the corresponding coupon, and the user equipment 400 executes the corresponding specific app based on the information for automatically executing the corresponding specific app and may display the coupon through the executed specific app.

Further, in the case of using the coupon stored in the user equipment 400, the coupon stored in the user equipment 400 is recognized through the coupon apparatus 100 or the POS terminal 500.

Further, in order to perform the payment function for one or more products to which the coupon is applied, the user equipment 400 performs the payment function for one or more products to which the corresponding coupon is applied by interlocking with the coupon apparatus 100, the service providing device 200, the POS terminal 500, the payment server (not illustrated), and the like.

Further, the user equipment 400 outputs or stores a payment function performed result (alternatively, payment information).

The POS terminal 500 communicates with the coupon apparatus 100, the service providing device 200, the beacon 300, the user equipment 400, and the like.

Further, in order to perform the payment function for one or more products to which the coupon is applied, the POS terminal 500 recognizes the coupon stored in the user equipment 400.

Further, the POS terminal 500 may receive information on the coupon recognized in the coupon apparatus 100 from the corresponding coupon apparatus 100.

Further, the POS terminal 500 may perform the payment function for one or more products to which the corresponding coupon is applied by interlocking with the service providing device 200, the user equipment 400, the payment server, and the like.

Further, the POS terminal 500 provides the payment function performed result to the service providing device 200, the user equipment 400, the payment server, and the like.

As such, the coupon may be issued according to a real-time sales situation of the store by a simple operation in a non-affiliated/affiliated store.

Further, as such, it is possible to issue the coupon which a coupon discount rate, a discount time, a quantity, and the like are adjusted in real time at a desired time of the coupon provider.

Hereinafter, a control method of the coupon issuing system according to the present invention will be described in detail with reference to FIGS. 1 to 8.

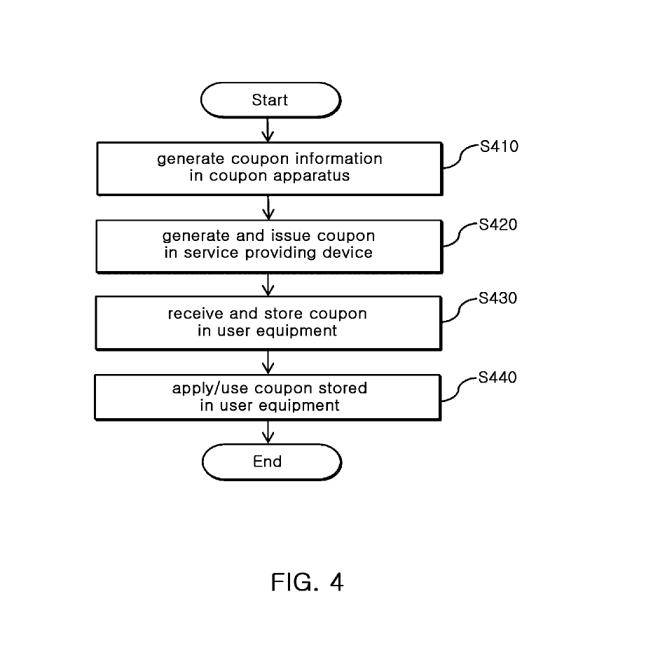

FIG. 4 is a flowchart illustrating a control method of a coupon issuing system according to a first embodiment of the present invention.

First, the coupon apparatus 100 sets (alternatively, generates) coupon information. In this case, the coupon information includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short distance from the store, a location base based on the store, an optimal location base based on store based business type related area information, a predetermined range/radius/distance, and the like). Here, the setting (alternatively, generating) of the coupon information may be performed on a screen displayed on the display unit 130 included in the coupon apparatus 100 or performed by operating (alternatively, controlling) the plurality of dials 150 included in the coupon apparatus 100 corresponding to the set values included in the coupon information, respectively. Further, the display unit 130 and the plurality of dials 150 interlock with each other and thus, the dials 150 corresponding to the values included in the coupon information set in the display unit 130 may be automatically applied (alternatively, changed) according to the setting of the display unit 130. In addition, the values included in the coupon information set in the dials 150 are applied to the display unit 130 according to the setting of the dials 150 and thus, the state of the corresponding display unit 130 may be changed.

Further, the coupon apparatus 100 transmits the set (alternatively, generated) coupon information to the service providing device 200. In this case, in the case where the location base based on the store, the optimal location base based on store based business type related area information, the predetermined range/radius/distance, and the like are included in the coupon issuance range information included in the coupon information, the coupon apparatus 100 transmits the set coupon information to the service providing device 200. Further, in the case where the in-store, the predetermined short distance from the store, and the like are included in the coupon issuance range information included in the coupon information, the coupon apparatus 100 may transmit the set coupon information to the beacon 300.

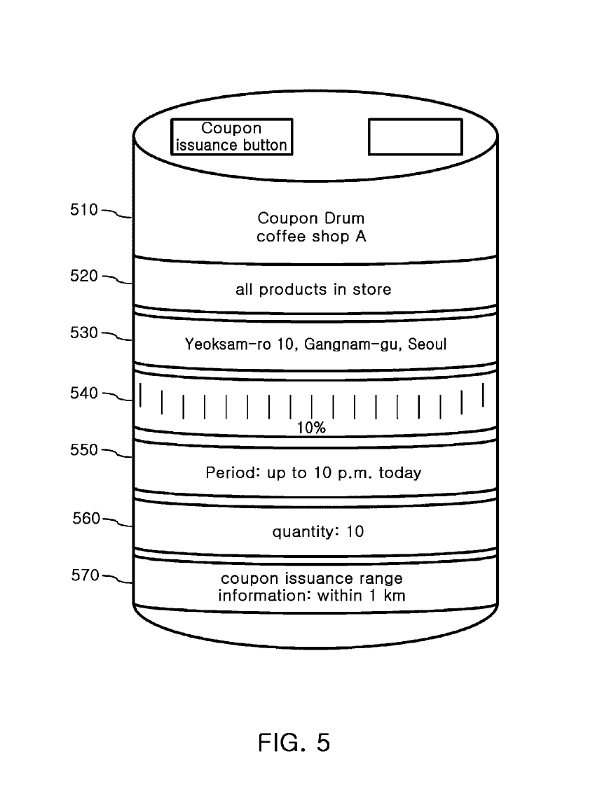

As an example, as illustrated in FIG. 5, the coupon apparatus 100 sets first coupon information including a store name 510 (for example, a coffee shop A), a product name 520 (for example, all products in the store), store location information 530 (for example, Yeoksam-ro 10, Gangnam-gu, Seoul), a discount rate 540 (for example, 10%), a period 550 (for example, up to 10:00 p.m. today), a quantity 560 (for example, a remaining quantity of 10), coupon issuance range information 570 (for example, within 1 km from the store based on the location around the store), and the like, through the plurality of dials 150 installed at one side of the coupon apparatus 100 by the operation of a store owner (alternatively, a coupon provider/coupon issuer) of the store installed with the corresponding coupon apparatus 100. In this case, the first coupon information set through the plurality of dials 150 may be simultaneously displayed on the display unit 130. Further, the coupon apparatus 100 transmits the set coupon information to the service providing device 200 based on the coupon issuance range information. Here, the store name or the store location information may be pre-set (S410).

Thereafter, the service providing device 200 receives the coupon information transmitted from the coupon apparatus 100.

Further, the service providing device 200 generates a coupon based on the coupon information and broadcasts (alternatively, transmits/issues) the generated coupon within a predetermined radius from the store where the corresponding coupon apparatus 100 is positioned. In this case, the generated coupon includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), a barcode or QR code, and the like.

As an example, the service providing device 200 generates a first coupon based on the first coupon information transmitted from the coupon apparatus 100 and broadcasts the first coupon generated above based on the coupon issuance range information included in the received first coupon information within a radius of 1 km from the corresponding coupon apparatus 100. In this case, the corresponding first coupon includes a store name (for example, a coffee shop A), a product name (for example, all products in the store), store location information (for example, Yeoksam-ro 10, Gangnam-gu, Seoul), a discount rate (for example, 10%), a period (for example, up to 10:00 p.m. today), a quantity (for example, a remaining quantity of 10), a barcode (alternatively, a QR code), and the like (S420).

Thereafter, the user equipment 400 receives the coupon transmitted from the service providing device 200 and stores the received coupon in the user equipment 400. In this case, the corresponding user equipment 400 receives the coupon transmitted from the corresponding service providing device 200 through a dedicated app pre-installed in the user equipment 400 and may store the received coupon by interlocking with the corresponding app.

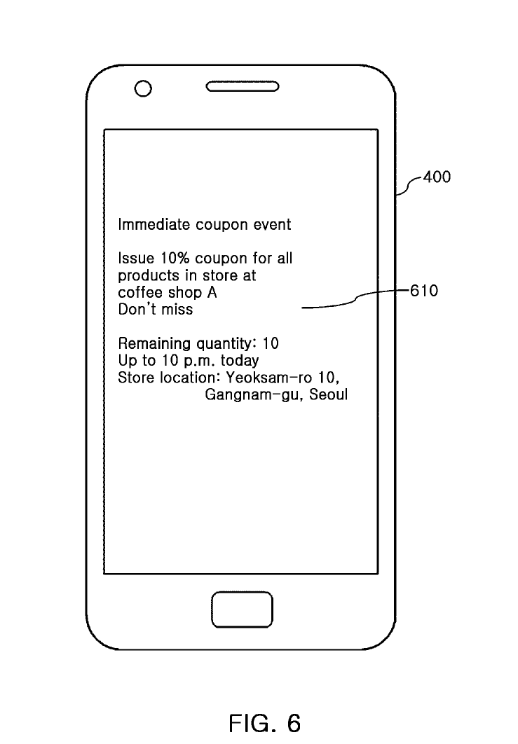

As an example, as illustrated in FIG. 6, one or more user equipment 400 positioned within a radius of 1 km from the store where the coupon apparatus 100 is positioned receive the first coupon transmitted from the service providing device 200 through the dedicated app and displays 610 and stores the received first coupon through the dedicated app (S430).

Thereafter, in the case of using the coupon stored in the user equipment 400, the coupon apparatus 100 or the POS terminal 500 which is installed in the store recognizes the coupon stored in the corresponding user equipment 400.

Further, the coupon apparatus 100 or the POS terminal 500 performs the payment function for the payment amount to which the corresponding coupon is applied and provides (alternatively, transmits) a payment function performed result (alternatively, payment information) to the corresponding user equipment 400 by interlocking with the corresponding user equipment 400 and the payment server (not illustrated).

As an example, in the case of using the first coupon stored in the user equipment 400, the POS terminal 500 installed at the coffee shop A capable of using the first coupon recognizes the first coupon stored in the corresponding user equipment 400, performs the payment function by interlocking with the user equipment 400 and the payment server with respect to the payment amount applying a discount rate (for example, 10%) included in the first coupon corresponding to an ordered coffee B, and provides payment function performed result information to the corresponding user equipment 400. Further, the corresponding user equipment 400 displays and stores the corresponding payment function performed result information through the dedicated app (S440).

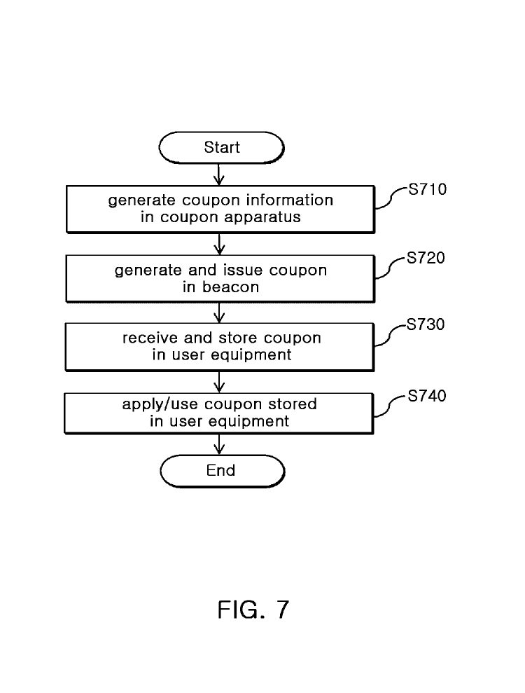

FIG. 7 is a flowchart illustrating a control method of a coupon issuing system according to a second embodiment of the present invention.

First, the coupon apparatus 100 sets (alternatively, generates) coupon information. In this case, the coupon information includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), coupon issuance range information (including, for example, in-store, a predetermined short range from the store, a location base based on the store, an optimal location base based on store based business type related area information, a predetermined range/radius/distance, and the like). Here, the setting (alternatively, generating) of the coupon information may be performed on a screen displayed on the display unit 130 included in the coupon apparatus 100 or performed by operating (alternatively, controlling) the plurality of dials 150 included in the coupon apparatus 100 corresponding to the set values included in the coupon information, respectively. Further, the display unit 130 and the plurality of dials 150 interlock with each other and thus, the dials 150 corresponding to the values included in the coupon information set in the display unit 130 may be automatically applied (alternatively, changed) according to the setting of the display unit 130. In addition, the values included in the coupon information set in the dials 150 are applied to the display unit 130 according to the setting of the dials 150 and thus, the state of the corresponding display unit 130 may be changed.

Further, the coupon apparatus 100 transmits the set (alternatively, generated) coupon information to the beacon 300. In this case, in the case where an in-store, a predetermined short distance from the store, and the like are included in the coupon issuance range information included in the coupon information, the coupon apparatus 100 may transmit the set coupon information to the beacon 300. Further, in the case where a location base based on the store, an optimal location base based on store based business type related area information, a predetermined range/radius/distance, and the like are included in the coupon issuance range information included in the coupon information, the coupon apparatus 100 may also transmit the set coupon information to the service providing device 200.

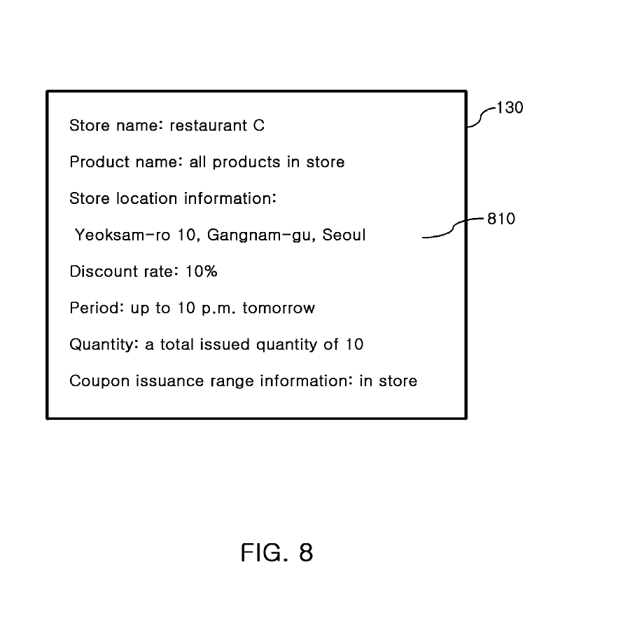

As an example, as illustrated in FIG. 8, the coupon apparatus 100 sets second coupon information including a store name (for example, a restaurant C), a product name (for example, all products in the store), store location information (for example, Yeoksam-ro 10, Gangnam-gu, Seoul), a discount rate (for example, 10%), a period (for example, up to 10 p.m. tomorrow), a quantity (for example, a total issued quantity of 10), coupon issuance range information (for example, in-store), and the like on a screen 810 displayed on the display unit 130. In this case, the second coupon information set through the display unit 130 may be matched with the plurality of dials 150, respectively. Further, the coupon apparatus 100 transmits the set coupon information to the service providing device 200 based on the coupon issuance range information (S710).

Thereafter, the beacon 300 receives the coupon information transmitted from the coupon apparatus 100.

Further, the beacon 300 broadcasts (alternatively, transmits/issues) a coupon having a BLE beacon signal form at a predetermined time interval in the store where the corresponding beacon 300 is positioned based on the coupon information. In this case, the coupon broadcasted (alternatively, transmitted/issued) by the beacon 300 includes a store name, a product name (including, for example, a specific product name, all products in the store, and the like), store location information, a discount rate (including, for example, a discount rate for each product, all same discount rates, and the like), a period (alternatively, a coupon expiration date), a quantity (including, for example, a remaining quantity, a total issued quantity, and the like), a barcode or QR code, and the like.

As an example, the beacon 300 converts the second coupon information transmitted from the coupon apparatus 100 into the second coupon having the BLE beacon signal form and broadcasts the second coupon having the BLE beacon signal form converted above at an interval of 100 ms in store where the corresponding beacon 300 is installed based on the coupon issuance range information included in the received second coupon information. In this case, the corresponding second coupon (alternatively, the second coupon having the BLE beacon signal form) includes a store name (for example, a restaurant C), a product name (for example, all products in the store), store location information (for example, Yeoksam-ro 10, Gangnam-gu, Seoul), a discount rate (for example, 10%), a period (for example, up to 10 p.m. tomorrow), a quantity (for example, a total issued quantity of 10), a barcode (alternatively, a QR code), and the like (S720).

Thereafter, the user equipment 400 receives the coupon transmitted from the beacon 300 and stores the received coupon in the user equipment 400. In this case, the corresponding user equipment 400 receives the coupon transmitted from the corresponding beacon 300 through a dedicated app pre-installed in the user equipment 400 and may store the received coupon by interlocking with the corresponding app.

As an example, the corresponding user equipment 400 positioned in the store where the beacon 300 is positioned receives the first coupon transmitted from the beacon 300 through the dedicated app and displays and stores the received first coupon through the dedicated app (S730).

Thereafter, in the case of using the coupon stored in the user equipment 400, the coupon apparatus 100 or the POS terminal 500 which is installed in the store recognizes the coupon stored in the corresponding user equipment 400.

Further, the coupon apparatus 100 or the POS terminal 500 performs the payment function for the payment amount to which the corresponding coupon is applied and provides (alternatively, transmits) a payment function performed result (alternatively, payment information) to the corresponding user equipment 400 by interlocking with the corresponding user equipment 400 and the payment server (not illustrated).

As an example, in the case of using the second coupon stored in the user equipment 400, the coupon apparatus 100 installed at the restaurant C capable of using the second coupon recognizes the second coupon stored in the corresponding user equipment 400 and provides information related with the recognized second coupon to the POS terminal 500. Further, the POS terminal 500 performs the payment function by interlocking with the user equipment 400 and the payment server with respect to the payment amount applying the discount rate (for example, 10%) included in the second coupon corresponding to an ordered food D and provides payment function performed result information to the corresponding user equipment 400. Further, the corresponding user equipment 400 displays and stores the corresponding payment function performed result information through the dedicated app (S740).

The coupon issuing system according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the coupon apparatus, the service providing device, the user equipment, and the like according to the embodiment of the present invention to implement the coupon issuing system.

The non-transitory computer readable storage medium includes a magnetic storage medium, an optical storage medium, and a carrier wave medium. The computer program implementing the coupon issuing system according to the embodiment of the present invention may be stored and installed in embedded memories of the coupon apparatus, the service providing device, the user equipment, and the like. Alternatively, external memories such as a smart card storing and installing the computer program implementing the coupon issuing system according to the embodiment of the present invention may be installed on the coupon apparatus, the service providing device, the user equipment, and the like through an interface.

As described above, according to the embodiment present invention, it is possible to issue a coupon in a non-affiliated store and improve convenience of a user by easily issuing the coupon, by issuing the coupon according to a real-time sales situation of the store by a simple operation in a non-affiliated/affiliated store.

Further, it is possible to maximize a coupon issuing effect by controlling the coupon issuance according to a situation of stores which a coupon provider belong to by issuing a coupon of which a coupon discount rate, a discount time, a quantity, and the like are adjusted in real time at a desired time of the coupon provider.

The present invention has advantages of issuing a coupon even in a non-affiliated store and improve convenience of a user by easily issuing the coupon, by issuing the coupon according to a real-time sales situation of the store by a simple operation in a non-affiliated/affiliated store and can be widely used in an advertisement field, a service business field, a BLE field, a user equipment field, a product sales field, a service providing device field, and the like.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

What is claimed is:

1. A coupon apparatus comprising:
a main body;
a display unit formed on one surface of the main body and configured to receive input values for a plurality of items for generating coupon information according to a user's touch;
a plurality of dials formed on the other surface of the main body and configured to select the input values for the plurality of items for generating the coupon information according to a user's operation;
a control unit configured to set the coupon information based on the input values received through the display unit or selected through the plurality of dials; and
a communication unit configured to transmit the set coupon information to a beacon or a service providing device.

2. The coupon apparatus of claim 1, wherein the coupon information includes at least one of a store name, a product name, store location information, a discount rate, a period, a quantity, and coupon issuance range information, and the coupon issuance range information includes at least one of in-store, a predetermined short distance from the store, a location base based on the store, an optimal location base based on store based business type related area information, and a predetermined range.

3. The coupon apparatus of claim 1, wherein the display unit and the plurality of dials interlock with each other, and when input values to be included in the coupon information is received from the display unit, a state of the dials corresponding to the input values received from the display unit is changed according to the received input values, and when the input values to be included in the coupon information are selected from the dials, a screen of the display unit corresponding to the input values selected from the dials is changed according to the selected input values.

4. The coupon apparatus of claim 1, wherein the control unit controls the communication unit to generate a coupon based on the set coupon information and broadcast the generated coupon based on the coupon issuance range information included in the coupon information.

5. The coupon apparatus of claim 4, wherein the coupon includes at least one of a store name, a product name, store location information, a discount rate, a period, a quantity, a barcode, and a QR code.

6. A control method of a coupon apparatus comprising:
receiving input values for a plurality of items for generating coupon information according to a user's touch by means of a display unit which is formed one surface of a main body;
receiving the input values for the plurality of items for generating the coupon information according to a user's operation by means of a plurality of dials which is formed on the other surface of the main body;
setting coupon information including at least one of a store name, a product name, store location information, a discount rate, a period, a quantity, and coupon issuance range information based on the input values received through the display unit or the plurality of dials by means of a control unit;
generating a coupon including at least one of a store name, a product name, store location information, a discount rate, a period, a quantity, a barcode, and a QR code based on the set coupon information by means of a communication unit; and
broadcasting the generated coupon based on the coupon issuance range information included in the coupon information by means of the communication unit.

7. The control method of the coupon apparatus of claim 6, wherein the broadcasting of the generated coupon includes at least one of:
broadcasting the coupon in the store where a coupon apparatus including the communication unit is installed by means of the communication unit, when the in-store is included in the coupon issuance range information;
broadcasting the coupon within a predetermined distance in the store by means of the communication unit, when the predetermined short distance from the store is included in the coupon issuance range information;
broadcasting the coupon within a predetermined radius from the store by means of the communication unit, when the location base based on the store is included in the coupon issuance range information; and
broadcasting the coupon within a predetermined area based on the corresponding store based on pre-analyzed commercial area information by means of the communication unit, when the optimal location base based on store based business type related area information is included in the coupon issuance range information.

8. A non-transitory computer readable storage medium having a computer program recorded thereon configured to perform the control method of the coupon apparatus of claim 6.

9. A non-transitory computer readable storage medium having a computer program recorded thereon configured to perform the control method of the coupon apparatus of claim 7.

10. A coupon issuing system comprising:
a coupon apparatus configured to set coupon information by means of a screen displayed on a display unit or a plurality of dials and transmit the set coupon information;
a service providing device configured to generate a coupon based on the coupon information transmitted from the coupon apparatus and broadcast the generated coupon based on coupon issuance range information included in the coupon information;
a beacon configured to generate the coupon based on the coupon information transmitted from the coupon apparatus and broadcast the generated coupon in the store or within the predetermined distance from the store based on the coupon issuance range information included in the coupon information; and
user equipment configured to receive the coupon broadcasted from the service providing device or the beacon and store the received coupon.

11. The coupon issuing system of claim 10, further comprising:
a POS terminal configured to recognize the coupon stored in the user equipment and perform a payment function for a payment amount to which the recognized coupon is applied, in the case of using the coupon stored in the user equipment.
